(19) United States
(12) Patent Application Publication
(10) Pub. No.: US 2026/0231093 A1
(43) Pub. Date: Aug. 6, 2026

(54) METHODS AND APPARATUSES FOR VERIFICATION OF WIRELESS DEVICE LOCATION OVER SATELLITE ACCESS NETWORK

(71) Applicant: SHENZHEN TCL NEW TECHNOLOGY CO., LTD., Shenzhen, Guangdong (CN)

(72) Inventor: Ahmed MOHAMMED MIKAEIL SALIH, Shenzhen, Guangdong (CN)

(73) Assignee: SHENZHEN TCL NEW TECHNOLOGY CO., LTD., Shenzhen, Guangdong (CN)

(21) Appl. No.: 19/151,290

(22) PCT Filed: Feb. 17, 2023
(86) PCT No.: PCT/CN2023/076898

§ 371 Date: Jul. 25, 2025

(51) Int. Cl. H04W 64/00; H04W 56/00; H04W 84/06

(52) U.S. Cl. CPC H04W 64/00; H04W 56/0015; H04W 84/06

(57) ABSTRACT

A method for verification of wireless device location over satellite access network includes exchanging of timing error correction information between a wireless device a satellite/terrestrial node, as a part of positioning protocol signaling to correct the error on estimation timing difference measured at the wireless device or the satellite so to mitigate the miss synchronization issue. Or alternatively, exchanging; between a wireless device and a satellite/terrestrial node, on the top of the timing error correction information, additional information such as the satellite orbital trajectories information, the beam identity (ID) at which the positioning reference signal being exchanged and/or the angular information (azimuth and/or elevation) of the positioning reference signal being measured at the wireless device or the satellite so to mitigate both miss-synchronization and mirror image ambiguity issues and/or to enhance a they performance accuracy of a positioning method.

### BACKGROUND OF DISCLOSURE

### 1. Field of the Disclosure

The present disclosure relates to the field of wireless communication systems, and more particularly, to methods and apparatuses for verification of wireless device location over satellite access network. For example, the present disclosure is related to providing a communication system and a group of methods to help mitigating the time difference estimation error and mirror image ambiguity issue when verifying the location of a wireless device accessing a wireless terrestrial network over satellite radio access technology.

### 2. Description of the Related Art

In Release 18, a work item [RP-223534] was carried out to define solutions enabling New Radio and NG-RAN to support Non-Terrestrial Networks (NTN). The detailed objectives include specifying enhancement features including NR-NTN coverage enhancement, mobility with service continuity enhancements and network verified UE location enhancements. For Network verified UE location detailed objective was to: 1. Mandate the network operator to cross check the UE location reported by the UE, which needs to be carried out in order to fulfil the regulatory requirements (e.g., Lawful intercept, emergency call, Public Warning System, . . . ) i.e., to recheck the UE reported location information (e.g. estimate UE location at the network side) and specify if needed mechanisms to fulfil the regulatory requirements. 2. Prioritize the specification of necessary enhancements to Multiple Round-Trip Time multi-RTT or Uplink/Downlink time difference of arrival DL/UL-TDOA positioning methods to support the network verified UE location in NTN assuming a single satellite in view [RAN1, 2, 3, 4]. 3. Reuse of the RAT only dependent positioning framework based on RAN1 conclusions (i.e., to avoid malicious UE from faking PLMN selection). 4. Verify UE location with a target accuracy similar to terrestrial network macro cell size (i.e., 5-10 km granularity) taking into account take into account the mirror-image ambiguity issue.

During the RAN1, 2, 3, and SA2 discussion/work regarding network verified UE location enhancements it was agreed in RAN1, that multi-RTT and DL/UL-TDOA RAT dependent positioning methods shall be considered as starting point for the study on Network verified UE location (Other methods (e.g., AoA based methods) are not precluded). While in RAN2, RAN3 it was agreed to postpone the work the on protocol and signaling enchantments until RAN1 finishes the evaluation of the agreed positioning.

During the RAN1, 2, 3, and SA2 discussion/work regarding network verified UE location enhancements it was agreed in RAN1, that time-based positioning methods such as multi-RTT and DL/UL-TDOA positioning methods to be considered as starting point for the study on Network verified UE location. These two methods make use of the measured reference signal timing difference (RSTD) or the time difference of arrival/departure (TDOA) of downlink/uplink signals received from/to multiple Transmission-Reception Points (TRPs) (i.e., a reference gNB and neighboring gNBs) at the same time. The resulting measurements are used along with other configuration information to locate the UE in relation to the neighboring TRPs (i.e., gNB or UE). The major issues of time-based positioning methods in NTN case are: 1. They require multiple satellite in view for collecting the positioning signal timing difference measurement for UE location verification, but due to the fact that coverage from multiples satellite is hard to achieve in NTN, the geometry of a virtual satellites at different time instance can be applied in NTN to address this issue. 2. They, require very tight synchronization between UE and satellite which is hard to achieve due to the satellite and possibly the UE movements, the synchronization error or the clock drift between the UE and satellite which could lead to the positioning error exceeding the required 5-10 km accuracy. 3. In case of single satellite in view, the time based positioning methods cannot resolve the ambiguity between a symmetric cells or beams with the respect to the satellite orbit plane. More specifically, it is very hard to locate the UE falling within the beams or the cells that underneath the satellite's orbital path (orbital plane) due to the mirror image ambiguity issue.

Therefore, a communication system and a group of methods are needed to address the tight synchronization requirement and the mirror image ambiguity issue which affects the accuracy performance of verification or locating the actual UE position.

### SUMMARY

An object of the present disclosure is to propose methods and apparatuses for verification of wireless device location over satellite access network, which can address tight synchronization and the mirror image ambiguity which affects UE positioning accuracy performance. The group of methods relies on exchanging of timing error correction information between a wireless device a satellite/terrestrial node, as a part of positioning protocol signaling to correct the error on estimation timing difference measured at the wireless device or the satellite so to mitigate the miss synchronization issue. Or alternatively, exchanging; between a wireless device and a satellite/terrestrial node, on the top of the timing error correction information, additional information such as the satellite orbital trajectories information, the beam identity (ID) at which the positioning reference signal being exchanged and/or the angular information (azimuth and/or elevation) of the positioning reference signal being measured at the wireless device or the satellite so to mitigate both miss-synchronization and mirror image ambiguity issues and/or to enhance a the accuracy performance of a positioning method.

In a first aspect of the present disclosure, a method for verification of wireless device location over satellite access network includes exchanging between a wireless device and a satellite/terrestrial node information about a wireless device location, a network node selection and/or a service access of the wireless device; exchanging between the satellite/terrestrial node and the wireless devices information about a positioning signal timing difference related measurement configuration and a positioning configuration assistance information; exchanging between the wireless device and satellite/terrestrial node information about a positioning signal reception/transmission timing; mitigating/correcting by the satellite/terrestrial node the error on timing measurement error at which an observed time difference for transmitting/receiving the positioning signal from the satellite/terrestrial node to the wireless device or from the wireless device to the satellite/terrestrial node is measured; resolving by the satellite/terrestrial node a mirror image ambiguity issue by using a satellite beam/cell ID and orbital trajectories and/or the angular information (azimuth and/or elevation) of the positioning reference signal being measured at the wireless device or the satellite provided by wireless device and/or the satellite/terrestrial node; and/or determining/verifying by the satellite/terrestrial node a final wireless device location compared to a wireless device reported location and exchanging information about a wireless device verified location locally and internally between nodes of the satellite/terrestrial node.

In a second aspect of the present disclosure, a communication system comprises a memory, a transceiver, and a processor coupled to the memory and the transceiver. The processor is configured to perform the above method.

In a third aspect of the present disclosure, a non-transitory machine readable storage medium has stored thereon instructions that, when executed by a computer, cause the computer to perform the above method.

In a fourth aspect of the present disclosure, a chip includes a processor, configured to call and run a computer program stored in a memory, to cause a device in which the chip is installed to execute the above method.

In a fifth aspect of the present disclosure, a computer readable storage medium, in which a computer program is stored, causes a computer to execute the above method.

In a sixth aspect of the present disclosure, a computer program product includes a computer program, and the computer program causes a computer to execute the above method.

In a seventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a diagram of an example of satellite access with satellite beams overlapping several countries.

FIG. 2 is a diagram of an example of time difference measurement error for multi/RRT DL-TDOA positioning method.

FIG. 3 is a diagram of an example of a wireless device under a beam/cell underneath satellite's orbital path suffer from mirror image ambiguity.

FIG. 4 is a flowchart illustrating a signaling and procedure design according to an embodiment of the present disclosure.

FIG. 5 is a diagram of estimating the time difference measurement for DL-TDOA single-satellite case according to an embodiment of the present disclosure.

FIG. 6 is a diagram of estimating the time difference measurement for Multi-RRT single-satellite case according to an embodiment of the present disclosure.

FIG. 7 is a diagram of deterring the satellite beams IDs in which UE can be located at a given time measurement instance according to an embodiment of the present disclosure.

FIG. 8 is a diagram of essential parameters for ephemeris according to an embodiment of the present disclosure.

FIG. 9 is a block diagram of a system for wireless communication according to an embodiment of the present disclosure.

FIG. 10 is a block diagram of one or more user equipments (UEs), a satellite, and one or more terrestrial nodes of communication in a communication network system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

This report provides a communication system and a group of methods to help reducing a wireless device (UE) position estimation uncertainty by mitigating the miss-synchronization error due to a measurement error of the observed time difference of arrival and/or departure of a positioning signal between wireless device a satellite/terrestrial access node, and/or mitigating the mirror image ambiguity issue of a positioning method to address the issue of a wireless device falling under a satellite cell/beam beneath the satellite orbital plane.

The group of methods relies on exchanging of timing error correction information between a wireless device a satellite/terrestrial node, as a part of positioning protocol signaling to correct the error on estimation timing difference measured at the wireless device or the satellite so to mitigate the miss synchronization issue. Or alternatively, exchanging; between a wireless device and a satellite/terrestrial node, on the top of the timing error correction information, additional information such as the satellite orbital trajectories information, the beam identity at which the positioning reference signal being exchanged and/or the angular information (azimuth and/or elevation) of the positioning reference signal being measured at the wireless device or the satellite so to mitigate both miss-synchronization and mirror image ambiguity issues and/or to enhance a the accuracy performance of a positioning method. The positioning method could be a time-based measurement positioning methods such as multi-RTT and DL/UL-TDOA positioning methods and/or other Agular-based measurement such as direction of arrival (DoA), angle of departure (AoD)

The major advantages of these group of methods include: 1. The new method helps reducing a wireless device (UE) position estimation uncertainty by mitigating the error on the observed time difference of arrival and/or departure of a positioning signal due to a miss-synchronization between wireless devices a satellite/terrestrial access node. 2. The new methods help addressing the mirror image ambiguity issue of wireless device falling under a satellite cell/beam beneath the satellite orbital plane which could affects the accuracy of the UE positioning estimation. The details of the procedures of group of the methods discussed in this disclosure are given in the following embodiments.

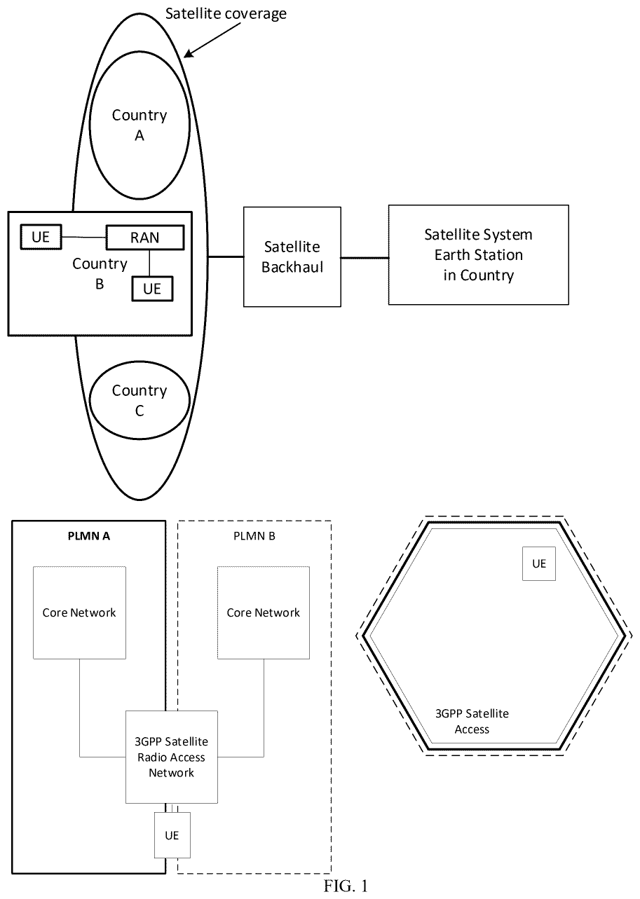

In terrestrial mobile network, when a UE attaches to the network, the radio access network (RAN) node selects the appropriate core network for the UE taking into account, among other things (TS 38.300): UE identifiers; UE's selected PLMN; UE location information (including the serving cell as known to the serving RAN node). With NTN it is possible to deploy very large cells over large portions of a continent (possibly covering different countries), with the different core networks for the various countries connected to the same NTN RAN (FIG. 1).

In such a scenario, it may not always be possible to correctly determine the appropriate core network for a connecting UE, this could impact the delivery of some regulatory service that require ideal UE location such as lawful intercept, emergency call, public warning system, charging, especially in the countries boarders, because the serving cell information may not be granular enough. Furthermore, a malicious UE might “fake” its selected PLMN in order to attempt connecting to a different core network. Upon such an attempt the AMF should be able to disconnect the UE and inform the RAN node via an appropriate action, so that the RAN can take appropriate action on subsequent attempts by the same UE. Therefore, a new 3gpp work item [RP-223534] was carried out in 3GPP release 18, targeting UE location verification with the following enhancements objectives:

1. Mandate the network operator to cross check the UE location reported by the UE,

2. Prioritize the specification of necessary enhancements to multi-RTT or DL-TDOA positioning methods to support the network verified UE location in NTN assuming a single satellite in view.

3. Reuse of the RAT only dependent positioning framework based on RAN1 conclusions (i.e., to avoid malicious UE from faking PLMN selection).

4. Verify UE location with a target accuracy similar to terrestrial network macro cell size (i.e., 5-10 km granularity) taking into account take into account the mirror-image ambiguity issue.

During the RAN1, 2, 3, and SA2 discussion/work regarding network verified UE location enhancements it was agreed in RAN1, that time-based positioning methods such as multi-RTT and DL/UL-TDOA positioning methods to be considered as starting point for the study on Network verified UE location. The major issues with these methods are:

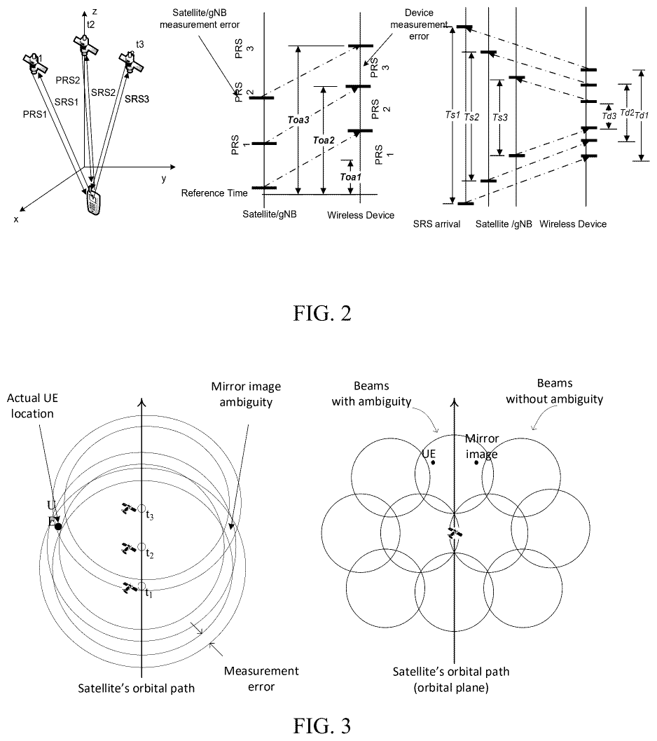

1. Require multiple satellite in view for collecting the positioning signal timing difference measurement for UE location verification due to the fact that multiples coverage is hard to achieve in NTN, are not available this NTN scenario but the use the geometry of a virtual satellites at different time instance can work in NTN (FIG. 2).

2. Require very tight synchronization between UE and satellite which is hard to achieve due to the satellite and possibly the UE movements, the synchronization error or the clock drift between the UE and satellite and/or which could lead to the positioning error exceeding the required 5-10 km (FIG. 2 and Table 1).

TABLE 1
UE position uncertainty area size under
Time difference error Multi-RRT

Resulting UE position uncertainty area (km)

| | RTT error = | RTT error = | RTT error = |
|---|---|---|---|
| | 300 ns | 100 ns | 50 ns |
| Scenario 1 | 224.7 | 74.9 | 37.4 |
| Scenario 2 | 38.2 | 12.7 | 6.3 |
| Scenario 3 | 24.5 | 8.1 | 4.0 |

In case of single satellite in view, the time based positioning methods cannot resolve the ambiguity between a symmetric cells or beams with the respect to the satellite orbit plane. More specifically, it is very hard to locate the UE falling within the beams or the cells that underneath the satellite's orbital path (orbital plane) due to the mirror image ambiguity issue (FIG. 2 and table 2).

TABLE 2
Positioning error performance for multi-
RTT with consideration of ambiguity issue

| | CDF = | CDF = | CDF = | CDF = | CDF = |
|---|---|---|---|---|---|
| | 50% | 67% | 80% | 90% | 95% |
| δ = 1 s | 21.84 km | 29.56 km | 37.97 km | 47.00 km | 54.78 km |
| δ = 5 s | 19.50 km | 27.08 km | 35.56 km | 45.05 km | 53.35 km |
| δ = 8 s | 6.66 km | 12.32 km | 14.94 km | 20.64 km | 24.87 km |

This report provides a communication system and a group of methods to help mitigating the time difference estimation error and the mirror image ambiguity issue when verifying the location of a wireless device accessing a wireless terrestrial network over satellite radio access technology. The details of the system and the methods are given in the following embodiments.

### Embodiment 1: Solution Protocol Signaling Description

This report provides a communication system and a group of methods to help reducing a wireless device (UE) position estimation uncertainty by mitigating the error on the observed time difference of arrival and/or departure of a positioning signal due to a miss-synchronization between wireless device a satellite/terrestrial access node and/or mitigating the mirror image ambiguity issue of a positioning method for wireless device falling under a satellite cell/beam beneath the satellite orbital plane.

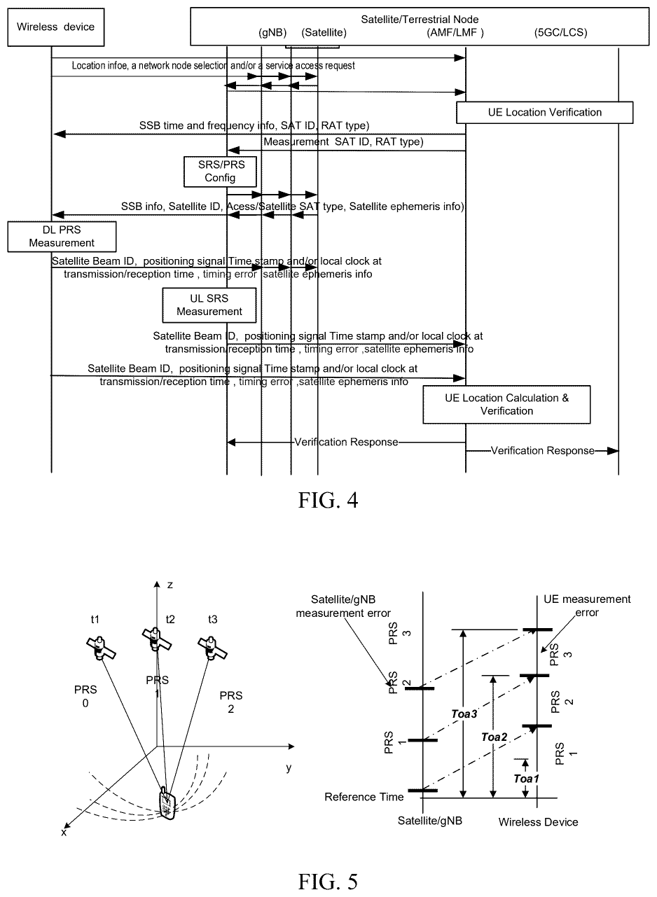

The communication system according to the above discussed method is depicted in FIG. 4, and the group of methods involve the following:

1. Exchanging between the wireless device and satellite/terrestrial node access related information such as the wireless device location, the wireless device network node selection request and/or the service access.

2. Exchanging between the satellite/terrestrial node and the wireless devices information about (1) a positioning signal timing related measurement configuration such as time stamp set to positioning signal and the actual time when positioning signal sent out to the wireless device by the satellite/terrestrial node and/or time difference error between the time stamp set to positioning signal and the actual time when positioning signal sent out as calculated according to method of embodiment 2 and (2) other positioning configuration assistance information such as the information about the satellite node identity, satellite type [e.g., Geostationary Orbit GEO, Middle Earth Orbit MEO, Low Earth Orbit (LEO)], satellite number of cells or beams and the time & frequency info of synchronization signal block (SSB) of the beam at which the positioning signal is transmitted.

3. Exchanging between the wireless device and satellite/terrestrial node information about positioning signal reception/transmission timing about such as the time stamp set to the positioning signal and the actual time when positioning signal sent out to the wireless device and/or the time difference error between the time stamp set to positioning signal and the actual time when positioning signal sent out as calculated according to method of embodiment 2. In addition to exchanging between the wireless device and satellite/terrestrial node other positioning measurement information such as the cell or beam identity in which the wireless device is located and/or the orbital trajectories of satellite where the wireless device is located.

4. Mitigating by the satellite/terrestrial node (based on the above information) the time error over which the observed time difference for transmitting/receiving the positioning signal from a satellite/terrestrial node to a wireless device or from a wireless device to satellite/terrestrial node is calculated according to the method of embodiment 2.

5. Resolving by the satellite or terrestrial network node mirror image ambiguity issue using the satellite beam/cell ID and orbital trajectories provided by wireless device and/or the satellite/terrestrial according to the method of embodiment 3.

6. Determining/verifying by the satellite terrestrial network node the final UE location compared to the wireless device reported location and exchanging the information about the UE verified location locally internally between the terrestrials network node, Access management (AMF)/location management function LMF and 5 g Core 5GC or Location Server LCS.

### Embodiment 2: Mitigating the Timing Difference Estimation Error

The major source for the timing difference estimation error for time based positioning methods like Multi-RTT and DL/UL-TDOA is the issue of synchronization error due to a drifts local clocks of the positional signal sender and receiver. If no synchronization error is assumed, for DL/UL-TDOA positioning method; the value of the reference signal timing difference (RSTD) between a satellite Satₜ at time instance t and a satellite Satₜ₊₁ at the time instance t+1 can be defined based on the observed time of arrival the of the positioning signals TOAᵢ and TOAⱼ at the satellite at different instance (as shown in FIG. 5), RSTD_{t,t+1}=TOAₜ₊₁−TOAₜ.

Each RSTD value that is obtained for a pair of satellites at different time instance corresponds to a hyperbola equation on which the UE is assumed to be located, with foci located at these satellites at different time instance. A set of hyperbola equations are deduced from a set of RSTD values, and the equations are solved to estimate the wireless device position.

Similarly, when no synchronization error is considered, for Multi-RRT method the RTT measurements can be computed as the Rx-Tx time difference measurements of downlink signals received from the same satellite, measured by the wireless device at multiple different instants (i.e. t, t+1 . . . ), and the measured Rx-Tx time difference measurements, of uplink signals transmitted from wireless device, measured by the satellite/terrestrial node at time instants (i.e. t, t+1 . . . ) is as given: RTTₜ=Tsₜ−Tdₜ.

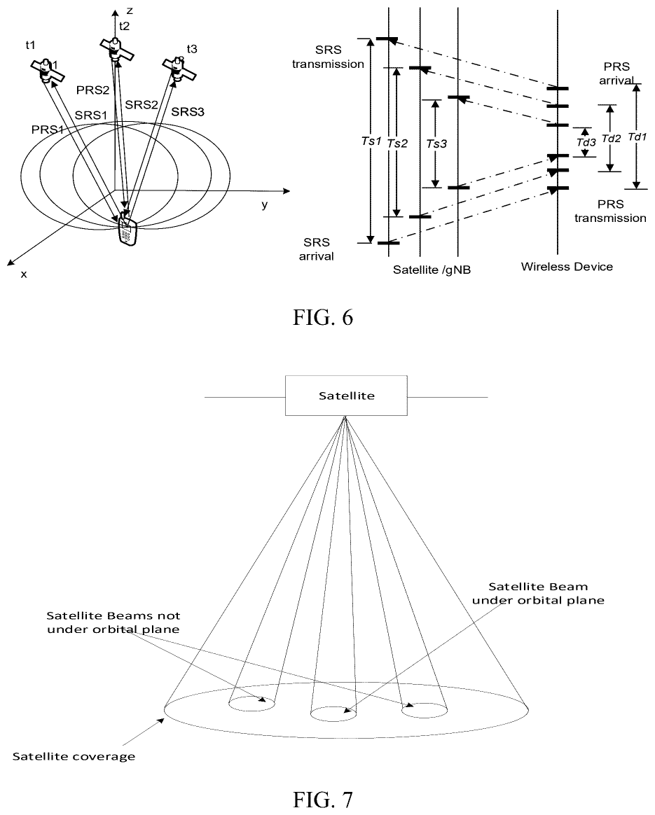

Each measured RTT corresponds to a circle he intersection of all the circles will point at the UE location (assumed not moving) (FIG. 6). In case of moving UE, the intersections will describe a line, with the direction of movement.

However, in practical NTN deployment, both the wireless device and the satellite/terrestrial node are likely to have synchronization error due to drifts in their local clocks, which will degrade the precision of the RSTD/RTT measurement. To cope with the following steps could be applied to estimate the error on RSTD/RTT measurement:

1. Estimating the time difference between the local clock of the wireless device and the clock used by the satellite/terrestrial node with respect to timestamp of the frame/transport block [protocol unit] carrying positioning signal (PRS/SRS) being sent as given: TimeDifferince=Tnow (wireless device)−TBTimeStamp, where Tnow is the time the packet is sent (current time), and TBTimeStamp is the timestamp set on the packet.

2. With the respect to a transport block of a positioning signal with Time Stamp (TBTimeStamp), the corresponding to local time at wireless device sending time transport block can be: Tnow (wireless device)=TimeDifferince+TBTimeStamp.

3. For the same transport block or frame of a positioning signal received at satellite/terrestrial node, the time difference is caused by the drift of the two clocks (wireless device and the satellite/terrestrial node) can be measured on every incoming TB or frame as: Timing error=[Tnow (satellite/terrestrial node)−(Tnow (wireless device))+delay for transmitting the positioning signal frame/transportblockform wireless device to the satellite/terrestrial node)]=Tnow (satellite/terrestrial node)−(TimeDifferince+TBTimeStamp+RRT/2).

Such Timing error can be reported to the network entity responsible for computing the wireless device location to correct the timing measurement error due to clock miss synchronization issue. For example the RTT measurements RTTₜ can be corrected as RTT_{t+/-} Timing error, similarly for RSTD_{t,t+1} can be corrected as +/−Timing error RSTD_{t,t+1}.

### Embodiment 3: Resolving Satellite Orbital Plane Ambiguity Issue

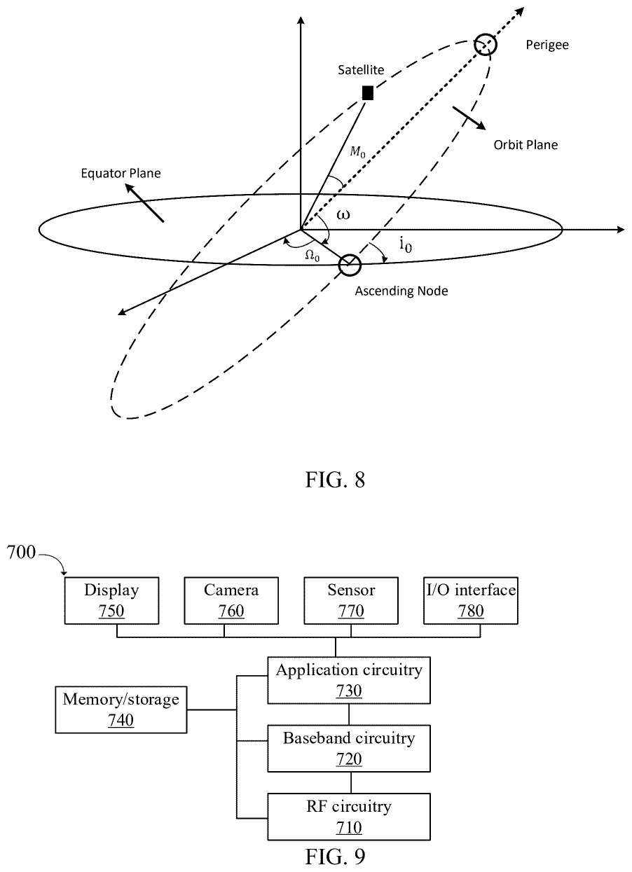

This issue happed for the wireless device which located in the beams/cells that are underneath the satellite's orbital path. To resolve this, the wireless device may determine based on the provided the time & frequency information of the synchronization signal block (SSB) of the beam in which the positioning signal is received, the associated satellite beam/cell ID. Then, the wireless device reports the associated beam ID along with the satellite orbital trajectories information such as ephemeris parameters and/or the angular information (e.g., the azimuth and/or elevation, the angle of arrival (AoA) or the direction of arrival (DoA), angle of departure (AoD)) of the uplink/downlink poisoning signal to the terrestrial network node to help to determining whether the beam/cell where the wireless device is located is below a satellite orbital path. If the it is determined that the beam/cell beam below a satellite orbital path the terrestrial network node may utilize ephemeris parameters and/or the angular information of the uplink/downlink poisoning signal along with positioning signal time difference related measurement for final location estimation and verification process (FIG. 7). The ephemeris parameters can be an orbital plane parameters such as e.g. semi-major axis, eccentricity, inclination, right ascension of the ascending node, argument of periapsis or a set of parameters used to determine exact satellite location at a given time such as mean anomaly at a reference point in time, and the epoch as given in FIG. 8 and Table 3.

TABLE 3
Essential Elements of Ephemeris

| | | |
|---|---|---|
| Orbital | \sqrt{a} | Square root of semi major axis (semi-major axis) |
| plane | e | Eccentricity (eccentricity) |
| parameters | i₀ | Inclination angle at reference time (inclination) |
| | Ω₀ | Longitude of ascending node of orbit plane (right |
| | | ascension of the ascending node) |
| | ω | Latitude: Argument of perigee (argument of periapsis) |
| Satellite | M₀ | Mean anomaly at reference time (true anomaly and a |
| level | | reference point in time) |
| parameters | t₀ₑ | Ephemeris reference time (the epoch) |

In summary, this disclosure provides a communication system and a group of methods to help mitigating the time difference estimation error and mirror image ambiguity issue when verifying the location of a wireless device accessing a wireless terrestrial network over satellite radio access technology. The major advantages of these methods include:

1. The new method helps reducing a wireless device (UE) position estimation uncertainty by mitigating the error on the observed time difference of arrival and/or departure of a positioning signal due to a miss-synchronization between wireless devices a satellite/terrestrial access node.

2. The new methods help addressing the mirror image ambiguity issue of wireless device falling under a satellite cell/beam beneath the satellite orbital plane which could affects the accuracy of the UE positioning estimation.

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single core or multi core processors. The processors may include any combination of general purpose processors and dedicated processors, such as graphics processors, application processors. The processors may be coupled with the memory/storage and configured to execute instructions stored in the memory/storage to enable various applications and/or operating systems running on the system.

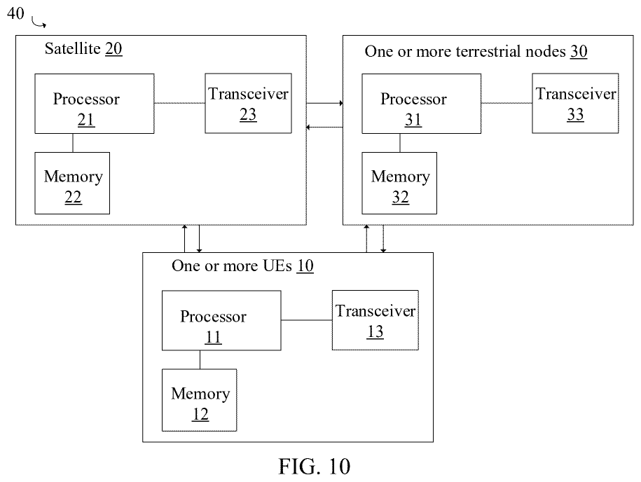

FIG. 10 illustrates that, in some embodiments, one or more UEs 10, a satellite 20, and one or more terrestrial nodes 30 (comprising gNB, AMF/LMF, and 5GC/LCS, etc.) for communication in a communication network system 40 according to an embodiment of the present disclosure are provided. The communication network system 40 includes the one or more UEs 10, the satellite 20, and the one or more terrestrial nodes 30. The one or more UEs 10 may include a memory 12, a transceiver 13, and a processor 11 coupled to the memory 12 and the transceiver 13. The satellite 20 may include a memory 22, a transceiver 23, and a processor 21 coupled to the memory 22 and the transceiver 23. The one or more terrestrial nodes 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31, and the transceiver 13, 23, or 33 transmits and/or receives a radio signal.

The processor 11, 21, or 31 may include application specific integrated circuit (ASIC), other chipset, logic circuit and/or data processing device. The memory 12, 22, or 32 may include read only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art. In some embodiments, the communication network system 40 is configured to perform the followings: exchanging between a wireless device and a satellite/terrestrial node information about a wireless device location, a network node selection of the wireless device, and/or a service access of the wireless device; exchanging between the satellite/terrestrial node and the wireless devices information about a positioning signal timing related measurement configuration and a positioning configuration assistance information; exchanging between the wireless device and satellite/terrestrial node information about a positioning signal reception/transmission timing; mitigating by the satellite/terrestrial node a time difference error over which an observed time difference for transmitting/receiving the positioning signal from the satellite/terrestrial node to the wireless device or from the wireless device to the satellite/terrestrial node; resolving by the satellite/terrestrial node a mirror image ambiguity issue using a satellite beam/cell ID and orbital trajectories provided by wireless device and/or the satellite/terrestrial node; and/or determining/verifying by the satellite/terrestrial node a final wireless device location compared to a wireless device reported location and exchanging information about a wireless device verified location locally and internally between nodes of the satellite/terrestrial node.

In some embodiments, the method for verification of wireless device location over satellite access network includes exchanging of timing error correction information between a wireless device a satellite/terrestrial node, to correct the error on estimation timing difference of a positioning reference signal and/or to enhance a performance accuracy of a positioning method. In some embodiments, the method for verification of wireless device location over satellite access network includes exchanging; between the wireless device and the satellite/terrestrial node, on the top of the timing error correction information, other additional assistance information such as the satellite orbital trajectories information, the beam identity (ID) on which the positioning reference signal is being exchanged, and/or the angular information of a positioning reference signal being measured at the wireless device or the satellite. In some embodiments, the method for verification of wireless device location over satellite access network includes utilizing the timing error correction information and other additional information by satellite/terrestrial node to mitigating miss-synchronization issue due to the timing error measurement and/or to resolving the mirror image ambiguity issues when verifying the location of a wireless device.

In some embodiments, the timing error correction information comprises a time stamp set to a positioning signal and/or an actual time when a positioning signal is sent out to the wireless device by the satellite/terrestrial node and/or the time difference error between the time stamp set to the positioning signal and the actual time when the positioning signal is sent out. In some embodiments, the additional assistance information comprises information about a satellite node identity, a satellite type, a satellite number of cells or beams, and/or a time/frequency information of a synchronization signal block (SSB) of the beam on which the positioning signal is transmitted provided by the satellite/terrestrial node to the wireless device. In some embodiments, the positioning method is time-based measurement positioning methods such as multi-RTT and DL/UL-TDOA positioning methods and/or other Agular-based measurement such as direction of arrival (DoA), angle of departure (AoD).

In some embodiments, the satellite orbital trajectories information comprises the ephemeris parameters which are either a set of parameters that used to determine the orbital plane of a satellite or a set of parameters that used to determine the exact satellite location at a given time. In some embodiments, the set parameters that used to determine the orbital plane of a satellite are at least one of semi-major axis, eccentricity, inclination, right ascension of the ascending node, argument of periapsis parameter. In some embodiments, the set of parameters used to determine exact satellite location at a given time are at least one of the means anomaly at a reference point in time, and the epoch time at which the satellite location is to be determined. In some embodiments, the angular information of a positioning reference signal comprises: the azimuth and/or elevation and or the angle of arrival (AoA) or the direction of arrival (DoA), angle of departure (AoD)) of the uplink/downlink poisoning signal.

In some embodiments, exchanging between the wireless device and satellite/terrestrial node information about the positioning signal reception/transmission timing further comprises exchanging between the wireless device and the satellite/terrestrial node a positioning measurement information comprising a cell or beam identity in which the wireless device is located and/or orbital trajectories of a satellite where the wireless device is located. In some embodiments, resolving by the satellite/terrestrial node a mirror image ambiguity issue using the satellite beam/cell ID and the orbital trajectories provided by wireless device and/or the satellite/terrestrial node further comprises: the wireless device determining based on the provided time/frequency information of the synchronization signal block (SSB) of the beam in which the positioning signal is received and/or the associated satellite beam/cell ID; and the wireless device reporting the associated beam ID along with the satellite orbital trajectories information and/or the angular information of the uplink/downlink poisoning signal. In some embodiments, if the beam/cell is determined to be below a satellite orbital path, the satellite/terrestrial node utilizes the ephemeris parameters and/or the angular information of the uplink/downlink poisoning signal along with a time difference measurement of the positioning signal for a final location estimation and a verification process. In some embodiments, exchanging the information about the wireless device verified location locally and internally between the nodes of the satellite/terrestrial node further comprises exchanging the information about the wireless device verified location locally and internally between an AMF/LMF and a 5GC or LCS.

In some embodiments, the positioning signal timing related measurement configuration comprises a time stamp set to a positioning signal and/or an actual time when the positioning signal is sent out to the wireless device by the satellite/terrestrial node and/or the time difference error between the time stamp set to the positioning signal and the actual time when the positioning signal is sent out.

In some embodiments, the time difference error is calculated according to at least one of the followings: estimating a time difference between a local clock of the wireless device and a clock used by the satellite/terrestrial node with respect to a time stamp of a frame/transport block carrying the positioning signal being sent as given: TimeDifferince=Tnow (wireless device)−TBTimeStamp, where Tnow is a time a packet is sent, TBTimeStamp is the time stamp set on the packet; with the respect to a transport block of the positioning signal with the time stamp (TBTimeStamp), the corresponding to local time the wireless device sending a time transport block is: Tnow (wireless device)=TimeDifferince+TBTimeStamp; and for the same transport block or frame of the positioning signal received at the satellite/terrestrial node, the time difference caused by a drift of two clocks of the wireless device and the satellite/terrestrial node is measured on every incoming TB or frame as: Timing error=[Tnow (satellite/terrestrial node)−(Tnow (wireless device))+delay for transmitting the positioning signal frame/transport block form wireless device to the satellite/terrestrial node)]=Tnow (satellite/terrestrial node)−(TimeDifferince+TBTimeStamp+RRT/2).

In some embodiments, the positioning configuration assistance information comprises information about a satellite node identity, a satellite type, a satellite number of cells or beams, and/or a time/frequency information of a synchronization signal block (SSB) of the beam on which the positioning signal is transmitted. In some embodiments, the positioning signal reception/transmission timing comprises the time stamp set to the positioning signal and the actual time when positioning signal is sent out to the wireless device and/or the time difference error between the time stamp set to the positioning signal and the actual time when the positioning signal is sent out. In some embodiments, exchanging between the wireless device and satellite/terrestrial node information about the positioning signal reception/transmission timing further comprises exchanging between the wireless device and the satellite/terrestrial node a positioning measurement information comprising a cell or beam identity in which the wireless device is located and/or orbital trajectories of a satellite where the wireless device is located.

In some embodiments, resolving by the satellite/terrestrial node a mirror image ambiguity issue using the satellite beam/cell ID and the orbital trajectories provided by wireless device and/or the satellite/terrestrial node further comprises: the wireless device determining based on the provided time/frequency information of the synchronization signal block (SSB) of the beam in which the positioning signal is received and/or the associated satellite beam/cell ID; and the wireless device reporting the associated beam ID along with the satellite orbital trajectories information comprising ephemeris parameters and/or the angular information (e.g., the azimuth and/or elevation, the angle of arrival (AoA) or the direction of arrival (DoA), angle of departure (AoD)) of the uplink/downlink poisoning signal to the satellite/terrestrial node to determine whether the beam/cell where the wireless device is located is below a satellite orbital path. In some embodiments, if the beam/cell beam is below a satellite orbital path, the satellite/terrestrial node utilizes the ephemeris parameters and/or the angular information of the uplink/downlink poisoning signal for a final location estimation and a verification process. In some embodiments, the ephemeris parameters comprise orbital plane parameters comprising a semi-major axis, an eccentricity, an inclination, a right ascension of an ascending node, an argument of periapsis, or a set of parameters used to determine an exact satellite location at a given time, and an epoch. In some embodiments, exchanging the information about the wireless device verified location locally and internally between the nodes of the satellite/terrestrial node further comprises exchanging the information about the wireless device verified location locally and internally between an AMF/LMF and a 5GC or LCS.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for verification of wireless device location over satellite access network, comprising:
exchanging between a wireless device and satellite/terrestrial node of timing error correction information and
satellite orbital trajectories information, to correct the error on estimation timing difference of a positioning reference signal and/or to enhance a performance accuracy of a positioning or
to resolve the mirror image ambiguity and/or to mitigate miss-synchronization due to the timing error measurement when verifying the location of a wireless device.

2. The method of claim 1, wherein the timing error correction information comprises a time stamp set to a positioning signal and/or an actual time when a positioning signal is sent out to the wireless device by the satellite/terrestrial node and/or the time difference error between the time stamp set to the frame block and/or transport block carrying positioning signal and the actual time when the positioning signal is sent out.

3. The method of claim 1, wherein the satellite orbital trajectories information comprises information about a satellite node identity, a satellite type, a satellite number of cells or beams, and/or a time/frequency information of a synchronization signal block (SSB) of the beam on which the positioning signal is provided by the satellite/terrestrial node to the wireless device.

4. The method of claim 1, wherein the positioning is time-based measurement positioning such as multi-RTT and DL/UL-TDOA positioning methods and/or other Agular-based measurement.

5. The method of claim 1, wherein the satellite orbital trajectories information comprises the ephemeris parameters which are either a set of parameters that used to determine the orbital plane of a satellite or a set of parameters that used to determine the exact satellite location at a given time.

6. The method of claim 5, wherein the set parameters that used to determine the orbital plane of a satellite are at least one of semi-major axis, eccentricity, inclination, right ascension of the ascending node, or argument of periapsis parameter.

7. The method of claim 5, wherein the set of parameters used to determine exact satellite location at a given time are at least one of the means anomaly at a reference point in time, and the epoch time at which the satellite location is to be determined.

8. The method of claim 1, wherein the angular information of a positioning reference signal comprises: the azimuth and/or elevation and and/or the angle of arrival (AoA) and/or the direction of arrival (DoA), and/or angle of departure (AoD)) of the uplink/downlink poisoning signal.

9. The method of claim 1, wherein the exchanging between the wireless device and satellite/terrestrial node information about the positioning signal reception/transmission timing comprises exchanging between the wireless device and the satellite/terrestrial node and positioning measurement information comprising a cell or beam identity in which the wireless device is located and/or orbital trajectories of a satellite where the wireless device is located.

10. The method of claim 1, wherein resolving by the satellite/terrestrial node a mirror image ambiguity using the satellite beam/cell ID and the orbital trajectories provided by wireless device and/or the satellite/terrestrial node further comprises: the wireless device determining based on the provided time/frequency information of the synchronization signal block (SSB) of the beam in which the positioning signal is received and/or the associated satellite beam/cell ID; and the wireless device reporting the associated beam ID along with the satellite orbital trajectories information and/or the angular information of the uplink/downlink poisoning signal.

11. The method of claim 8, wherein if the beam/cell is determined to be below a satellite orbital path, the satellite/terrestrial node utilizes the ephemeris parameters and/or the angular information of the uplink/downlink poisoning signal along with a time difference measurement of the positioning signal for a final location estimation and a verification process.

12. The method of claim 1, wherein exchanging the information about the wireless device verified location locally and internally between the nodes of the satellite/terrestrial node comprises exchanging the information about the wireless device verified location locally and internally between an AMF/LMF and a 5GC or LCS.

13. The method of claim 2, wherein for the frame block and/or transport block carrying positioning signal, a time difference caused by a drift of two clocks of the wireless device and the satellite/terrestrial node due to mobility, is measured on every incoming TB or frame.

14. A chip, includes a processor, configured to call and run a computer program stored in a memory, to cause a device in which the chip is installed to execute the method for verification of wireless device location over satellite access network, comprising:
exchanging between a wireless device and satellite/terrestrial node of timing error correction information and satellite orbital trajectories information, to correct the error on estimation timing difference of a positioning reference signal and/or to enhance a performance accuracy of a positioning or to resolve the mirror image ambiguity and/or to mitigate miss-synchronization due to the timing error measurement when verifying the location of a wireless device.

15. A computer readable storage medium, in which a computer program is stored, wherein the computer program causes a computer to execute the method for verification of wireless device location over satellite access network, comprising:
exchanging between a wireless device and satellite/terrestrial node of timing error correction information and satellite orbital trajectories information, to correct the error on estimation timing difference of a positioning reference signal and/or to enhance a performance accuracy of a positioning or to resolve the mirror image ambiguity and/or to mitigate miss-synchronization due to the timing error measurement when verifying the location of a wireless device.
